(19) United States
(12) Patent Application Publication
(10) Pub. No.: US 2021/0135770 A1
(43) Pub. Date: May 6, 2021

(54) UE Full Duplex Calibration For Mobile Systems

(71) Applicant: Nokia Technologies Oy, Espoo (FI)

(72) Inventors: Karol Schober, Helsinki (FI); Ryan Keating, Chicago, IL (US); Benny Vejlgaard, Gistrup (DK); Klaus Pedersen, Aalborg (DK)

(21) Appl. No.: 16/668,176

(22) Filed: Oct. 30, 2019

(51) Int. Cl. H04B 17/11; H04L 5/14

(52) U.S. Cl. CPC H04B 17/11; H04L 5/14

(57) ABSTRACT

A base station in a wireless network receives, from a UE in the wireless network, a message indicating the UE requests a gap for the UE to perform self-calibration of full-duplex communication. The base station determines the gap for the UE to use to perform the self-calibration of full duplex communication and sends indication of the gap toward the user equipment. The UE sends a message indicating the UE requests a gap in order for the UE to perform self-calibration of full duplex calibration. The UE receives, from the base station, indication of the gap. The UE performs the self-calibration of full duplex calibration using the gap.

### TECHNICAL FIELD

This invention relates generally to wireless communication and, more specifically, relates to full duplex wireless communication.

### BACKGROUND

In time division duplexing (TDD), duplex communication links are used where uplink is separated from downlink by the allocation of different time slots in the same frequency band. Users are allocated time slots for uplink (UL) and downlink (DL) transmission. That is, the same users use the same frequency band, and are separated in time.

By contrast, frequency division duplex (FDD) is a technique where separate frequency bands are used at the transmitter and receiver side. This means that users are separated by frequency but not by time.

In both of the TDD and FDD scenarios, if a user equipment (UE) in a wireless system is communicating with a base station in that system, each one communicates only in UL or in DL, but not both at the same time.

There has been a movement to full duplex (FD), where both the UE and base station can transmit and receive at the same time. FD brings its own set of issues, which can be improved upon.

### BRIEF SUMMARY

This section is intended to include examples and is not intended to be limiting.

In an exemplary embodiment, a method is disclosed that includes receiving, at a base station in a wireless network and from a user equipment in the wireless network, a message indicating the user equipment requests a gap for the user equipment to perform self-calibration of full-duplex communication. The method includes determining by the base station the gap for the user equipment to use to perform the self-calibration of full duplex communication. The method also includes sending by the base station indication of the gap toward the user equipment.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

An exemplary apparatus includes one or more processors and one or more memories including computer program code. The one or more memories and the computer program code are configured to, with the one or more processors, cause the apparatus to perform operations comprising: receiving, at a base station in a wireless network and from a user equipment in the wireless network, a message indicating the user equipment requests a gap for the user equipment to perform self-calibration of full-duplex communication; determining by the base station the gap for the user equipment to use to perform the self-calibration of full duplex communication; and sending by the base station indication of the gap toward the user equipment.

An exemplary computer program product includes a computer-readable storage medium bearing computer program code embodied therein for use with a computer. The computer program code includes: code for receiving, at a base station in a wireless network and from a user equipment in the wireless network, a message indicating the user equipment requests a gap for the user equipment to perform self-calibration of full-duplex communication; code for determining by the base station the gap for the user equipment to use to perform the self-calibration of full duplex communication; and code for sending by the base station indication of the gap toward the user equipment.

In another exemplary embodiment, an apparatus comprises: means for receiving, at a base station in a wireless network and from a user equipment in the wireless network, a message indicating the user equipment requests a gap for the user equipment to perform self-calibration of full-duplex communication; means for determining by the base station the gap for the user equipment to use to perform the self-calibration of full duplex communication; and means for sending by the base station indication of the gap toward the user equipment.

In an exemplary embodiment, a method is disclosed that includes sending, by a user equipment in a wireless network and toward a base station in the wireless network, a message indicating the user equipment requests a gap in order for the user equipment to perform self-calibration of full duplex calibration. The method includes receiving, at the user equipment and from the base station, indication of the gap. The method also includes performing by the user equipment the self-calibration of full duplex calibration using the gap.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

An exemplary apparatus includes one or more processors and one or more memories including computer program code. The one or more memories and the computer program code are configured to, with the one or more processors, cause the apparatus to perform operations comprising: sending, by a user equipment in a wireless network and toward a base station in the wireless network, a message indicating the user equipment requests a gap in order for the user equipment to perform self-calibration of full duplex calibration; receiving, at the user equipment and from the base station, indication of the gap; and performing by the user equipment the self-calibration of full duplex calibration using the gap.

An exemplary computer program product includes a computer-readable storage medium bearing computer program code embodied therein for use with a computer. The computer program code includes: code for sending, by a user equipment in a wireless network and toward a base station in the wireless network, a message indicating the user equipment requests a gap in order for the user equipment to perform self-calibration of full duplex calibration; code for receiving, at the user equipment and from the base station, indication of the gap; and code for performing by the user equipment the self-calibration of full duplex calibration using the gap.

In another exemplary embodiment, an apparatus comprises: means for sending, by a user equipment in a wireless network and toward a base station in the wireless network, a message indicating the user equipment requests a gap in order for the user equipment to perform self-calibration of full duplex calibration; means for receiving, at the user equipment and from the base station, indication of the gap; and means for performing by the user equipment the self-calibration of full duplex calibration using the gap.

### BRIEF DESCRIPTION OF THE DRAWINGS

In the attached Drawing Figures:

FIG. 1 is a block diagram of one possible and non-limiting exemplary system in which the exemplary embodiments may be practiced;

FIG. 2 illustrates examples of duplexing options;

FIG. 3 illustrates a simple model of circuitry in a full duplex UE;

FIG. 4 is a signaling diagram of a 2-STEP RACH procedure;

FIG. 5 is a signaling diagram and flowchart for UE full duplex self-calibration in an exemplary embodiment; and

FIG. 6 is a logic flow diagram performed by a UE for performing FD calibration.

### DETAILED DESCRIPTION OF THE DRAWINGS

The following abbreviations that may be found in the specification and/or the drawing figures are defined as follows:
3GPP third generation partnership project
5G fifth generation
5GC 5G core network
ACK acknowledgement
ADC analog to digital converter
AMF access and mobility management function
BW bandwidth
BWP bandwidth part
CA carrier aggregation
CB code book
CLI cross-link interference
CSI channel state information
CU central unit
DAC digital to analog converter
DCI downlink control information
DL downlink (from network to user equipment)
DMRS demodulation reference signal
DRV driver
DU distributed unit
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
FD full duplex
FDD frequency division duplexing
GC-PDCCH group common PDCCH
gNB (or gNodeB) base station for 5G/NR, i.e., a node providing NR user plane and control plane protocol terminations towards the UE, and connected via the NG interface to the 5GC
HARQ hybrid automatic repeat request
HW hardware (e.g., defined in, e.g., silicon)
I/F interface
IMU inertial measurement unit
LNA low noise amplifier
LO local oscillator
LTE long term evolution
MAC medium access control
MME mobility management entity
ng or NG next generation
ng-eNB or NG-eNB next generation eNB
NR new radio
N/W or NW network
OFDM orthogonal frequency division multiplexing
ORS orthogonal reference signal
PA power amplifier
PDCCH physical downlink control channel
PDCP packet data convergence protocol
PHY physical layer
PRB physical resource block
RAN radio access network
RACH random access channel
Rel release
RLC radio link control
RO random access occasion
RRH remote radio head
RRC radio resource control
RS reference signal
RSRP reference signal received power (reported in dBm)
RU radio unit
Rx receiver or reception
SDAP service data adaptation protocol
SGW serving gateway
SI self-interference
SIC self-interference cancellation
SLmAP SLm interface application protocol
SMF session management function
SSB synchronization signal block
SR scheduling request
SRS sounding reference signal
TDD time division duplexing
TP transmission point
TS technical specification
TSN time-sensitive network
Tx transmitter or transmission
UCI uplink control information
UE user equipment (e.g., a wireless, typically mobile device)
UL uplink (from user equipment to network)
UPF user plane function
URLLC ultra reliable low latency communication
U-TDOA uplink time difference of arrival

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The exemplary embodiments herein describe techniques for UE full duplex analogue calibration. Additional description of these techniques is presented after a system into which the exemplary embodiments may be used is described.

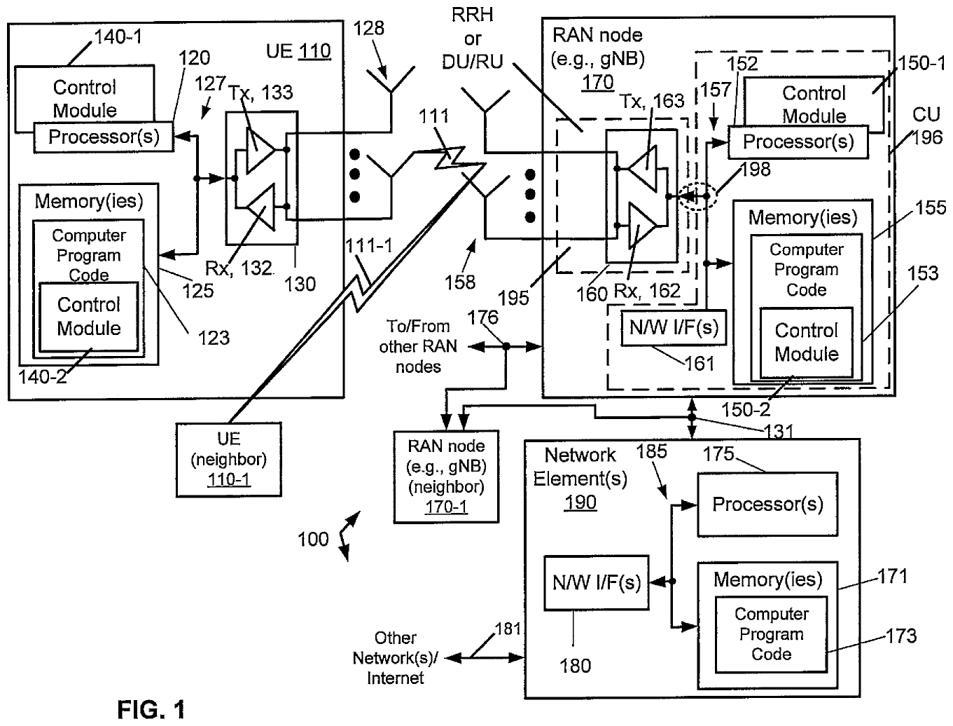

Turning to FIG. 1, this figure shows a block diagram of one possible and non-limiting exemplary system in which the exemplary embodiments may be practiced. A user equipment (UE) 110, radio access network (RAN) node 170, and network element(s) 190 are illustrated, as are a second UE 110-1 and a second RAN node 170-1.

In FIG. 1, the UE 110 is in wireless communication with a wireless network 100. A UE is a wireless, typically mobile device that can access a wireless network. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a control module 140, comprising one of or both parts 140-1 and/or 140-2, which may be implemented in a number of ways. The control module 140 may be implemented in hardware as control module 140-1, such as being implemented as part of the one or more processors 120. The control module 140-1 may be implemented also as an integrated circuit or through other hardware such as a programmable gate array. In another example, the control module 140 may be implemented as control module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The UE 110-1 is a neighbor UE and communicates with (at least) the RAN node 170 using the wireless link 111-1. The UE 110-1 is assumed to be similar to the UE 110.

The RAN node 170 is a base station that provides access by wireless devices such as the UE 110 (and UE 110-1) to the wireless network 100. The RAN node 170 may be, for instance, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface to a 5GC (e.g., the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of an RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a control module 150, comprising one of or both parts 150-1 and/or 150-2, which may be implemented in a number of ways. The control module 150 may be implemented in hardware as control module 150-1, such as being implemented as part of the one or more processors 152. The control module 150-1 may be implemented also as an integrated circuit or through other hardware such as a programmable gate array. In another example, the control module 150 may be implemented as control module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the control module 150 may be distributed, such as being distributed between the DU 195 and the CU 196, or be implemented solely in the DU 195.

The one or more network interfaces 161 communicate over a network such as via the links 176 and 131. Two or more RAN nodes 170, 170-1, or others communicate using, e.g., links 176. A link 176 may be wired or wireless or both and may implement, e.g., an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, e.g., fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that the base station that forms the cell will perform the functions. The cell makes up part of a base station. That is, there can be multiple cells per base station. For instance, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely exemplary functions that may be supported by the network element(s) 190, and note that both 5G and LTE functions might be supported. The RAN nodes 170, 170-1 are coupled via links 131 to a network element 190. A link 131 may be implemented as, e.g., an NG interface for 5G, or an Si interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The RAN node 170-1 is a neighbor to RAN node 170, and is assumed to be similar to RAN node 170. In the text below, both RAN nodes 170 and 170-1 are referred to as gNBs (or gNodeBs), for ease of reference. This is not a limitation on the nodes, however.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances (including Internet of Things devices) permitting wireless Internet access and possibly browsing, tablets with wireless communication capabilities, as well as portable units or terminals that incorporate combinations of such functions.

Having thus introduced one suitable but non-limiting technical context for the practice of the exemplary embodiments of this invention, the exemplary embodiments will now be described with greater specificity.

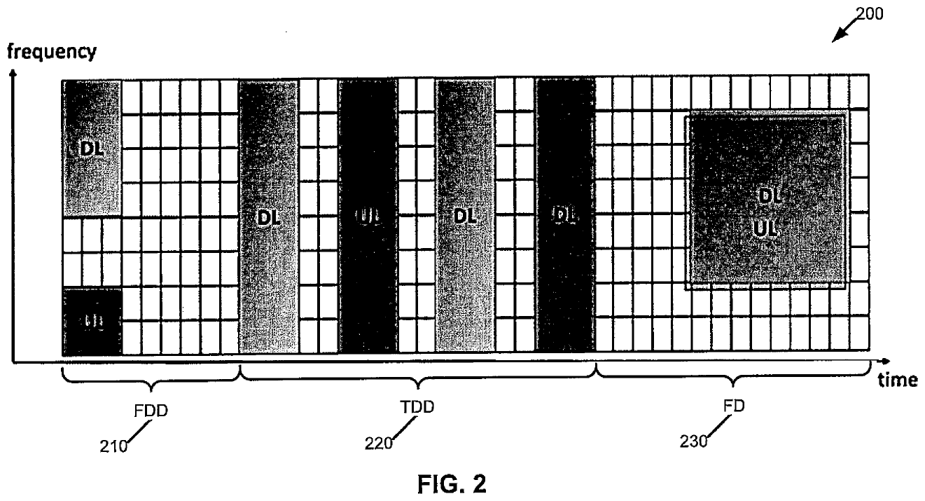

The current 3GPP NR Rel-15 specifications support frequency division duplexing (FDD) and time division duplexing (TDD) modes. See FIG. 2, which illustrates examples of duplexing options. This illustrates a time-frequency resource space 200. Each column corresponds to a time period, such as that used for a symbol. Each row corresponds to a frequency range, typically referred to as a subcarrier. Each element in the time-frequency resource space 200 may be referred to as a resource element.

For FDD 210, non-overlapping carriers are configured for the downlink (DL) and uplink (UL) transmissions, respectively. FDD 210 does not utilize spectrum efficiently as UL and DL frequencies are allocated statically. In this example, DL and UL for FDD 210 are separated by frequency.

TDD (e.g., TDD 220) implies that a cell either has exclusive UL, DL, or no transmission for each time-instant (such as a time period illustrated by a column in the time-frequency resource space 200). Hence, no option for simultaneous UL and DL (as is the case for FDD) is supported in NR Rel-15. For instance, in FIG. 2, the DL and UL regions are separated in time in TDD 220. This is especially a challenge for URLLC and TSN use cases, where multiple simultaneously active UEs must be served immediately and therefore often require a cell to have simultaneous UL and DL to accommodate the strict latency (e.g., no more than 1 ms) and ultra-reliability requirements for all users.

A solution to meet these stringent requirements is full-duplex (FD) operation, which is expected to be introduced in future 3GPP NR releases and promises to increase the throughput. FD 230 is illustrated in FIG. 2, and FD enables a device to receive and transmit simultaneously in the same frequency band using the same time resources, i.e. the device uses dedicated TX and RX chains for transmission and reception in the same PRBs simultaneously. This is illustrated by FIG. 2, where the UL and DL occur using the same frequency and time resources.

FD however comes with the limitation of self-interference (SI) and residual SI, in which the TX chain leaks a non-negligible amount of energy onto the RX chain, contaminating the received signal.

A variation of FD implementation, in which both the gNB 170 and the UE 110 operate in FD mode, is called bi-directional FD. In some deployments, only the gNB 170 can be capable of FD, while UEs are capable of half-duplex only, i.e., one-directional FD. It is envisioned that full duplex will be specified in Rel. 17 and/or Rel. 18.

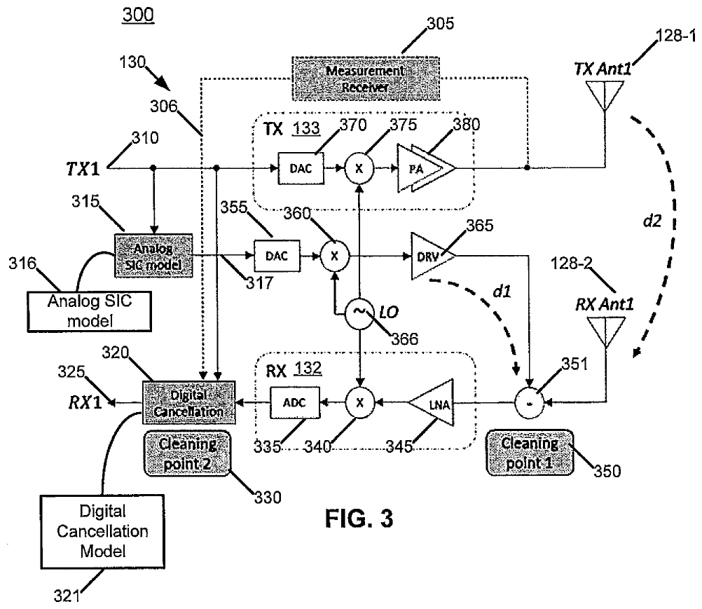

Turning to FIG. 3, this figure illustrates a simple model of circuitry 300 in a full duplex UE 110. For instance, the circuitry 300 can comprise the transceiver 130 of FIG. 1 and other elements toward the antennas 128. The UE comprises a TX (transmission) Ant1 (antenna) 128-1 and an RX (reception) ANT1 (antenna) 128-2, a measurement receiver 305, a transmitter 133 (comprising a digital to analog converter (DAC) 370, a multiplier 375, and a power amplifier (PA) 380), a transmission TX1 signal line 310, analog SIC model circuitry 315, a DAC 355, a multiplier 360, a driver (DRV) 365, a local oscillator (LO) 366, digital cancellation circuitry 320 (e.g., defined in hardware, HW), a receiver (RX) 132 (comprising an analog to digital converter (ADC) 335, a multiplier 340, and a low noise amplifier (LNA) 345), a subtractor 351, two cleaning points 1 350 and 2 330, and a reception RX1 signal line 325.

Since both the TX 133 and RX 132 are operating at the same time in FD mode, the transmission over TX Ant1 128-1 causes SI to the RX Ant1 128-2. There is a path through the analog SIC model circuitry 315 (e.g., also typically implemented in HW), the DAC 355, the multiplier 360, and the DRV 365 to the subtractor 351 that attempts to perform SIC and compensate for analog interference. This is performed at the (analog) cleaning point 1 350. The analog SIC model circuitry 315 implements an analog SIC model 316 and produces an output 317 based on the model 316. There is also a path through the measurement receiver 305 and to the digital cancellation circuitry 320 that also attempts to perform SIC and compensate for interference, but this time in the digital domain. This is performed at the (digital) cleaning point 2 330. The digital cancellation circuitry 320 implements a digital cancellation model 321 and updates the model 321 at least by comparing digital data from transmission TX1 signal line 310 and the digital data on the output 306 of the measurement receiver 305. It is further noted that each of the elements in FIG. 3 may also be considered to be means for performing their corresponding functions. For example, the subtractor 351 could be a means for performing subtraction, and the DAC 355 could be a means for converting digital signals to analog signals, and the like.

In more detail, as illustrated in FIG. 3, the basic assumptions for UE full duplex include the following:

1) Self-interference cancellation (SIC) is required for maintaining specification compliant receiver performance.

2) Solutions also require significant RX/TX isolation, as digital SIC gain is not adequate in itself.

3) The receiver 132 has a dynamic range limitation and solutions require a first TX cleaning stage (cleaning point 1 350) in the analog domain to prevent RX saturation by TX prior to the LNA 345.

One of the key problems to enable full duplex on a UE (such as a handheld device) is to identify the transfer function from the UE TX antenna to the UE RX antenna. Once the transfer function is identified then the needed SIC can be applied. Consider the following:

1) The target is to model the transfer function of path (d2) with path (d1) to have a residual error at cleaning point 1 350 that can be handled in the digital domain.

2) The transfer function of path (d2) can be characterized for gNB or devices without human interaction.

3) For handheld devices as the UE 110, the path (d2) will be impacted by the human touch (loading effect and mismatch).

4) One problem is to characterize the path (d2) under dynamic conditions.

5) Methods are required for the following: Factory calibration; and Adaptive live operation update of alignment.

Key problems to perform cleaning point 1 350 (the analog cleaning point) include the following:

1) The resolution of the ADC 335 is kept to a minimum due to cost and power consumption.

2) The dynamic range of the ADC 335 is critical for the UE performance.

3) Thus, the residual error after cleaning point 1 350 should be kept at a minimum.

4) The calculation of the analog cleaning point 1 350 requires that the interference from other transmit points should be muted or minimized.

The solution for the adaptive live operation update of alignment will require changes to 3GPP specifications to enable low interference (i.e., transmit points should be muted or minimized) during the cleaning point 1 350 operation. One exemplary motivation for the adaptive live operation update of alignment is that users touching the device will change the characteristic from TX-to-RX and thus the factory calibration characterizing the TX-to-RX transfer function will become invalid and a live update is required.

At a higher level, the top-level concept of FD was earlier proposed to be part of 3GPP NR Rel-16 studies. However, it was postponed until later releases to keep the workload for Rel-16 reasonable. Earlier proposals to have FD and other flexible duplexing studies appear in 3GPP RP-172483 and RP-172636, respectively: Huawei, “New WID on NR Uu Interface Enhancement”, 3GPP TSG RAN Meeting #78, RP-172483, Lisbon, Portugal, Dec. 18-21, 2017; and LG Electronics, China Telecom, “New SI proposal: Study on flexible and full duplex for NR”, 3GPP TSG RAN Meeting #78, RP-172636, Lisbon, Portugal, Dec. 18-21, 2017.

Related to this subject matter are RACH procedures in NR. In R15 (Release 15), only 4-step RACH is supported, in R16 (Release 16), 2-step RACH is specified. The two-step RACH procedure reduces the latency of RACH procedure as compared to the current 4-Step RACH procedure used today in Release 15 but will result in increased UL overhead.

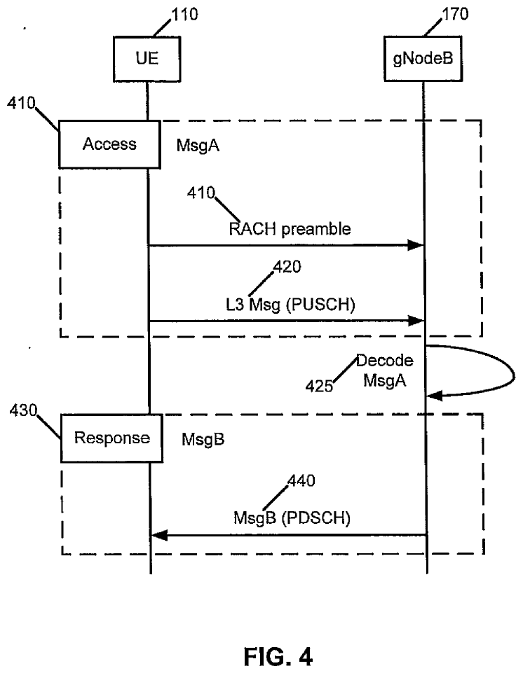

The 2-Step RACH procedure condenses the preamble and Msg3 from the 4-Step RACH into MsgA which consists of a preamble and PUSCH occasion for sending uplink data. Similarly, RACH response and Msg4 from 4-Step RACH and condensed into a single MsgB. This is as shown in FIG. 4, which is a signaling diagram of a 2-STEP RACH procedure. In FIG. 4, there is an access part 410 and a response part 430. In the access part 410, there is RACH preamble signaling 410 and L3 Msg (PUSCH) signaling 420. The eNodeB 170 decodes the MsgA, see reference 425. In the response part 430, the eNodeB 170 responds with MsgB (PDSCH) signaling 440.

Consider also a scheduling request (SR) in NR. In NR, a UE can be configured with up to 8 SR configurations per cell group per bandwidth part (BWP). The SR is used for requesting UL-SCH (uplink-shared channel) resources for a new transmission. The MAC entity may be configured with zero, one, or more SR configurations. An SR configuration includes a set of PUCCH resources for SR across different BWPs and cells. For a logical channel, at most one PUCCH resource for SR is configured per BWP. Each SR configuration corresponds to one or more logical channels. Each logical channel may be mapped to zero or one SR configuration, which is configured by RRC. The SR configuration of the logical channel that triggered the BSR (buffer status report) (if such a configuration exists) is considered as corresponding SR configuration for the triggered SR.

However, none of these addresses the issues described above or conflicts with the proposals herein. To address these and other issues, exemplary methods and signaling involved are disclosed for online calibration of full duplex in the UE, and these enable full-blown bi-directional FD.

As an overview, a set of procedures are proposed here that enables the UE to perform online adaptive live operation update of alignment characterization of the transfer function from the active TX antenna to the active RX antenna.

During such operation, the UE 110 will be allocated dedicated physical resources, coordinated by the gNB with simple gNB and UE procedures. Exemplary methods capture in RX the UE-known TX signal using both UL TX gaps and DL measurement gaps. Both the main TX/RX RF leakage path and TX cleaning path may be connected during the measurement. External echoes can be detected by setting reasonable delay threshold with reference to an expected maximum radio front-end group delay. The reflected signal can be removed by signal processing. The measurement requires DL reception gaps to have only TX residual signal present during test and delay adjustment. The measurement requires UL transmission gaps to allow the UE to transmit a reference signal. Potentially, during this UL transmission gap, the network will also mute other transmission points (TPs). Past full duplex simulations and analysis have shown that the additional interference generated by an FD network is quite significant. Without a method to allow both the UL transmission gap and muting of other TPs, the performance of self-interference cancellation by the UE would be degraded.

Certain exemplary embodiments introduce “sounding slots/OFDM symbols” and time matching “blank slot/OFDM symbols”. The purpose of these sounding/blank slots/OFDM symbols is to allow an estimate of the UL to DL self-induced interference. Once a UE determines the need for self-calibration, the UE switches to half duplex mode until the calibration procedure has been completed.

In general, exemplary proposed procedures might include the following.

A UE indicates to a gNB that a gap for self-calibration is required and switches to half-duplex mode. The UE will trigger a self-calibration based on changes in the TX-to-RX leakage. The UE will signal to the gNB that half duplex is only supported until a re-calibration has occurred. An alternative embodiment is to introduce periodic slots for FD UE self-calibration.

In an exemplary embodiment, the gNB and the UE determine a gap for self-calibration. The gNB requests muting of neighbor gNBs, the muting occurring during the symbols of the gap (e.g., the requests signaled via, e.g., an Xn interface). The gNB sends signaling to neighbor UEs of the UE performing the calibration to mute the neighbors at least during the symbols of the gap (e.g., the gNB also avoiding scheduling neighbors during this pre-aligned slot). A neighbor UE is, e.g., a transmitting entity that can be heard with a signal above a noise floor. A neighbor gNB is, e.g., a gNB that is not the serving cell for the UE.

The UE performs its self-calibration using the gap. The UE informs the gNB that full duplex is supported again after re-calibration. The gNB can now schedule the UE for full duplex.

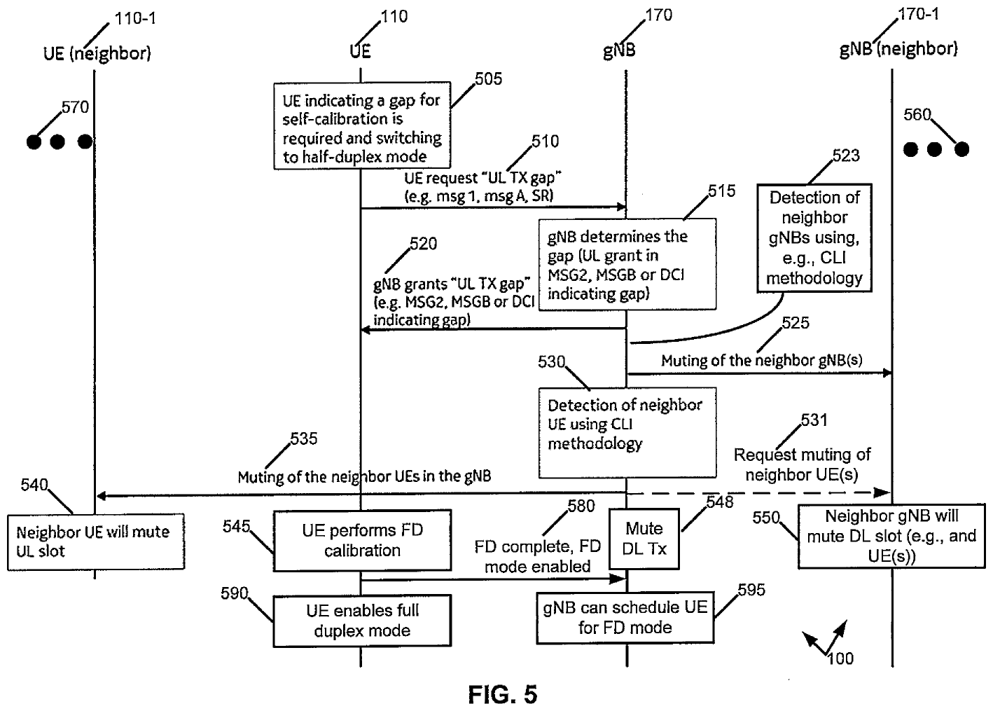

Now that an introduction has been given, additional details are presented. Refer to FIG. 5, which is a signaling diagram and flowchart for UE full duplex self-calibration in an exemplary embodiment. This figure also illustrates the operation of an exemplary method or methods, a result of execution of computer program instructions embodied on a computer readable memory, functions performed by logic implemented in hardware, and/or interconnected means for performing functions in accordance with exemplary embodiments. In FIG. 5, the blocks and other operations performed are performed by a UE 110 (or UE 110-1) under control at least in part by the control module 140, or by a gNB 170 (or gNB 170-1) under control at least in part by the control module 150.

In block 505, the UE indicates a gap for self-calibration is required and may switch to half-duplex mode, meaning that full duplex mode will not be used for communication with the gNB until after self-calibration. The UE in signaling 510 requests a “UL TX gap” (e.g., using possibly MSG 1, MSG A, SR). Concerning indicating the need for calibration gap, exemplary reasons to have dedicated FD calibration slots include the following: The residual error for the analogue “cleaning point 1” needs to be minimized, thus one has to mute the RX and interference to a minimum; and/or The user/human impact on the handset is the reason for the change in the TX-to-RX transfer function.

To indicate a need for calibration gap, a UE may employ some of the following modified existing techniques as examples:

1) A modified MSG 1 (from a 4 step-RACH procedure), where a specific subset of RACH occasions (RACH occasions) may be dedicated (configured to a UE in dedicated manner) for the indication of need for the calibration gap.

2) A modified MSG A (from a 2 step-RACH procedure), where a configured PUSCH associated with the preamble/RO (e.g., a physical resource and root-sequence/cyclic shift, which is associated with a detected SSB/beam) may contain a 1 (one) bit flag indicating the need for the calibration gap.

3) A modified SR. One or more out of eight SR configurations may be linked to the calibration gap-request instead of a logical channel.

4) A new UCI bit attached to a DL assignment HARQ-ACK CB. Upon gNB scheduling DL assignment, a UE provides one more bit in the HARQ-ACK CB to indicate the need for the calibration gap for each cell in the group of cells configured to a UE. That is, if carrier aggregation (CA) is configured to a UE, there is only one PUCCH cell within a group of cells in CA, where HARQ-ACK is transmitted. Therefore, HARQ-ACK CB contains ACKs for PDSCH transmitted on each of the cells within the group of cells.

All of the above options are technically feasible. However, considering that the calibration would be required only for the connected UE, the modified SR is a suitable option, as this option minimizes signaling overhead and requires very little specification effort.

In block 515, the gNB 170 determines the gap, such as determining a silence gap within the serving and neighbor cells. More specifically, the gNB determines based on its scheduler when a gap can be scheduled. The gap is signaled via an UL grant in MSG2, MSGB or DCI indicating the gap. See signaling 520, where the gNB 170 grants the “UL TX gap” using, e.g., MSG2, MSGB, or DCI indicating the gap.

With respect to determining the calibration gap by a UE that indicated need for the gap, in response to indication of “need for calibration gap” to the gNB, a UE determines the gap for calibration by receiving a modified UL grant in MSG2, MSGB or DCI indicating the gap. The UL is modified relative to a current UL grant that is being used. This modified UL grant might include one or more of the following.

1) A frequency domain resource allocation field indicates invalid allocation. That is, based on the invalid allocation, the UE then knows certain material indicates the UL resources to be used for FD calibration. More specifically, this is MSG2,B, DCI, so the gNB indicates TD-RA (time division-resource allocation) of the gap, but sets FD-RA (frequency division-resource allocation) to invalid allocation.

2) The UE interprets the SLIV field from an UL grant as symbols of gap. The SLIV is a Start and Length Indicator Value for the time domain allocation for PDSCH. A gap as small as 2OS (two OFDM symbols) is possible with this mechanism.

3) The UE interprets the K2 field as the slot where the gap is scheduled. Up to 32 slots can be indicated by the gNB.

4) As the earliest gap among a set of possible preconfigured gaps, where the earliest gap after reception (including processing time) of MSG2,B, DCI that provides a response to UEs request “need for calibration gap”. In more detail for processing time, when an indication is sent, it takes certain amount of time to process the information, and this is referred as “processing time”. Also, if the gNB indicates to the UE to transmit a signal, additional delay is required for UE to prepare transmission (in this case, e.g., SRS). Processing delays in NR are typically captured in a number of symbols. Thus, an example is the base station determines a symbol of the gap as an earliest gap in a set of gaps, the earliest gap occurring after at least one of the received messages indicating the user equipment requests the gap or sending the indication of the gap, such that processing timelines are met.

The configuration of gap(s) may include: periodicity [e.g., in slots]; offset [e.g., in slots]; a bitmap indicating the symbol(s) of the gap within the slot; and/or offset of a reservation signal with respect to the gap. These would be indicated by the gNB 170 to the UE 110 in signaling 520. The reservation signal should be transmitted before the gap. It is noted that the signaling may be used as in signaling 520, but it is also possible for one option could be preconfigured, and no dynamic signaling would be needed in MSG2, MSGB or DCI. This might not be implemented that often (e.g., as it reserves resources somewhat “permanently”), but is listed here as an option.

The gNB 170 can perform muting of both neighbor UEs and neighbor gNBs. One option for discover of these neighbors uses CLI, which is cross link interference. Using this technique, either a UE or a gNB can measure interference from a neighbor cell. A UE can measure interference from another UE in either the same cell or in a neighbor cell. The same goes from a gNB, which can measure interference from other gNBs. Thus, related to the techniques herein, the CLI methodology can be used to detect any interference that needs to be muted. The instant techniques are not limited to CLI, and other techniques may be used. For example, the gNB 170 might find neighbor gNBs 170-1 using Automatic Neighbor Relations (ANR) or similar techniques.

In block 523, the gNB 170 detects neighbor gNBs using one or more techniques such as CLI methodology. In block 525, the gNB 170 performs muting (e.g., via an X2 interface) of the detected neighbor gNB(s), of which one gNB 170-1 is shown. Ellipses 560 indicate other neighbor gNBs 170-1 may also be muted.

In one embodiment, gNB to gNB signaling (e.g., over an X2 interface) can indicate the configured resources for UE self-calibration transmission and request muting. Alternatively, this could follow a similar procedure to SRS configuration sharing performed for positioning purposes (i.e., for UTDOA) and if similar protocol to SLmAP is introduced in NR, this could be reused for full duplex gap configuration sharing.

With regard to muting of the neighbor UEs, in block 530, the gNB 170 performs detection of neighbor UEs using, e.g., CLI methodology. There are two levels of CLI, inter-cell and intra-cell. For UEs being close to a cell center, it would be sufficient to have intra-cell CLI. This would not need coordination within the network 100. For cell edge users, by contrast, cross-gNB coordination (i.e., intra-cell CLI) might be required, e.g., to allow neighbor gNBs 170-1 to mute neighbor UEs in the cell(s) of the neighbor gNBs 170-1. Thus, as an optional technique, the gNB 170 may request (see signaling in reference 531) muting of neighbor UE(s) from neighbor gNB(s) 170-1.

The gNB 170 also performs signaling in reference 535 of muting neighbor UEs in the gNB. This signaling may include an indication of the gap (e.g., those resources where the neighbor UE is not to transmit) or at least an indication there should be a silence period, e.g., for some duration. The ellipses 570 indicate there could be multiple neighbor UEs 110-1. With respect to the muting of the neighbor UEs in the gNB, it is possible to use GC-PDCCH signaling of flexible symbols for a gap. However, since CLI is dynamic, one issue is how to deliver muting to the target group of UEs. Of course, a baseline technique is to mute all UEs 110 in the cell and neighboring cells. Muting of all UEs in the cell is, however, non-ideal from cell efficiency point of view. One possible better approach could include one or more of the following:

1) Allow the gNB to override flexible symbols by dynamic scheduling DCI for UEs (possible in R15). By default, UEs are silent during flexible symbols; however if the gNB scheduled PDSCH or PUSCH, the UE follows this scheduling. A gNB may therefore indicate a symbol (or symbols) as flexible in GC_PDCCH and then schedule PDSCH or PUSCH on top of those. As such, some UEs remain silent and other UEs transmit or receive the scheduled data channel.

2) Instruct the UEs with the need for calibration gap to transmit a reservation signal, and the UEs that hear the reservation signals mute during the duration of the gap. This allows multiple UEs requiring FD calibration, which would need different gaps/slots for doing so, to be addressed.

At the scheduled time for the gap, the neighbor UE(s) 110-1 in block 540 mutes its UL slot, the UE 110 in block 545 performs its FD calibration, the gNB 170 in block 548 mutes its DL transmission, and the neighbor gNB(s) 170-1 in block 550 mute their DL slot. In block 550, the neighbor gNB 170-1 may also mute neighbor UE(s).

Concerning the UE performing its self-calibration using the UL TX gap, the UE can use SRS symbols for self-calibration as one example. SRS is defined, for instance, in 3GPP TS 38.211 (clause 6.4.1.4). As an extension in an exemplary embodiment, a new SRS usage for self-calibration can be introduced into RRC specifications to indicate to the UE that those specific SRS symbols will have low interference and should be used for self-calibration purposes. As an alternative, existing SRS usage may be used by the UE for self-calibration purposes with for example addition of another field inside the existing usages or other signaling to indicate that a particular configuration of SRS can be used for UE self-calibration. The gNB 170 sends an indication of these specific SRS symbols, and the UE knows these are to be used as a gap (or gaps). In other words, this exemplary self-calibration procedure reuses already existing transmission of SRS (used by gNB for CSI estimation), and as such the interference in the network is not increased due to self-calibration. The UE can take advantage of a staggered SRS structure in the frequency domain that is being introduced in Rel-16 to calibrate over the full BW (e.g., without requiring low interference over the full band for any one symbol. A staggered SRS structure as a configured SRS resource in which the occupied subcarriers are changed from symbol to symbol, such that all the subcarriers with a given PRB are occupied during the duration of the SRS resource. A full BW may refer to a carrier BW configured to a UE or a BW of configured a BW part (BWP) which is currently active.

In signaling 580, the UE indicates to the gNB 170 that the FD is complete and the FD mode is enabled. In block 590, the UE 110 enables the FD mode and the gNB in block 595 can schedule the UE for FD mode.

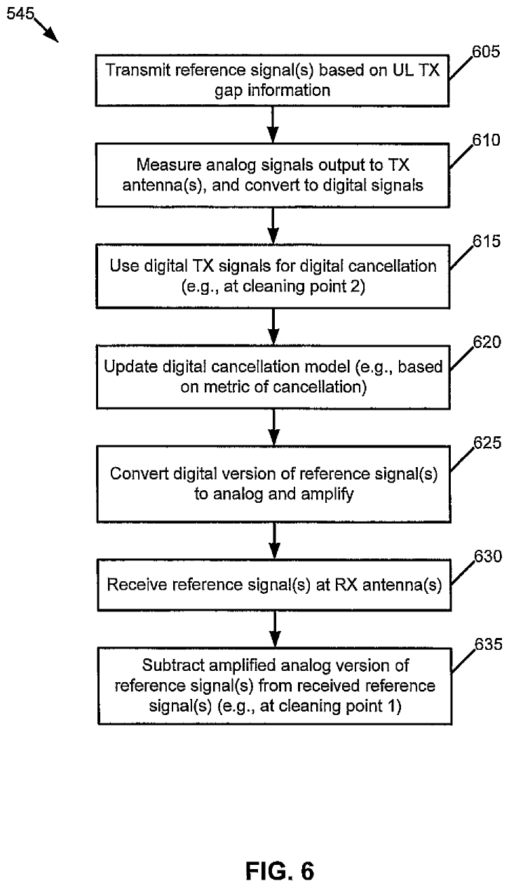

Turning to FIG. 6, this figure is a logic flow diagram performed by a UE for performing FD calibration. This is meant to be an overview of FD calibration 545, as FD calibration is already known. FIG. 6 also illustrates the operation of an exemplary method or methods, a result of execution of computer program instructions embodied on a computer readable memory, functions performed by logic implemented in hardware, and/or interconnected means for performing functions in accordance with exemplary embodiments. The operations in FIG. 6 are performed by the UE 110, e.g., under control of the control module 140. FIG. 3 is also referred to in this example, to illustrate the circuitry and corresponding means that could be used for this flowchart.

In this example, in block 605, the UE 110 transmits reference signal(s) based on UL TX gap information. This would be performed by the transmitter 133 via the TX ANT1 128-1 in the example of FIG. 3. The UE 110 in block 610 measures analog signals output to TX antenna(s), and converts to digital signals. In the example of FIG. 3, the measurement receiver 305 performs this functionality. The UE 110 in block 615 uses digital TX signals for digital cancellation (e.g., at cleaning point 2). The digital cancellation circuitry 320 in FIG. 3 implements this functionality. The digital cancellation model 321 is updated (e.g., based on a metric of cancellation) by the digital cancellation circuitry 320 in block 620.

In block 625, the UE 110 converts a digital version of reference signal(s) to analog and amplifies the analog version. In FIG. 3, this uses an analog SIC model circuitry 315 that implements an analog SIC model 316 and produces an output 317 based on the model 316. The SIC model 316 comprises a transfer function from TX to RX convolved with the TX signal. This will get updated over time and will contain the updated TX to RX transfer function after calibration. The baseline is typically calibrated during production of the device. The output 317 is a modified version of the reference signal(s) being transmitted. The DAC 355 converts this output 317 into an analog signal, the analog signal is passed through the multiplier 360 and the driver (DRV) 365 to the subtractor 351. In block 630, the UE 110 receives reference signal(s) at RX antenna(s). In FIG. 3, the RX Ant1 12-2 receives the transmitted signals. In block 635, the UE 110 subtracts the amplified analog version of reference signal(s) from received reference signal(s) (e.g., at cleaning point 1). In FIG. 3, the subtractor 351 subtracts the amplified analog version of reference signal(s) from the DRV 365 from the received reference signal(s) that have been received over the RX antenna Ant1 128-2. The output of the subtractor in FIG. 3 is forwarded to the receiver RX 132 for additional processing.

Other examples include the following. The TX sounding symbol can use that of SRS symbols (used in UL currently), although other symbols are possible. The UE full duplex calibration can be triggered periodically based on UE predetermined values stored in the UE. For instance, the UE full duplex calibration can be triggered based on environmental parameters such as one or more of the following: temperature; battery voltage; TX power (location in the cell); and/or IMU sensor data (movement or orientation change).

Additionally, the UE full duplex calibration can be triggered based on human interaction. For instance, this could be triggered based on a detected impedance mismatch in the PA or LNA on the UE.

Without in any way limiting the scope, interpretation, or application of the claims appearing below, exemplary advantages and technical effects of exemplary embodiments include one or more of the following: 1) Keep the dynamic range of the ADC in the UE at a minimum, which saves power and saves cost; 2) Enable full duplex in a UE with human contact (e.g., which causes variable loading PA and LNA).

The following are additional examples.

### EXAMPLE 1

A method, comprising:

receiving, at a base station in a wireless network and from a user equipment in the wireless network, a message indicating the user equipment requests a gap for the user equipment to perform self-calibration of full-duplex communication;

determining by the base station the gap for the user equipment to use to perform the self-calibration of full duplex communication; and

sending by the base station indication of the gap toward the user equipment.

### EXAMPLE 2

The method of example 1, further comprising:

sending requests to one or more user equipment that are neighbors to the user equipment and are in at least one cell formed by the base station, the requests indicating that the neighbor user equipment are to mute their uplink communications at least for the gap.

### EXAMPLE 3

The method of example 2, wherein sending the requests uses group common physical downlink control channel signaling of one or more flexible symbols to be used for the gap.

### EXAMPLE 4

The method of example 3, wherein sending the requests sends the requests to both the user equipment and the one or more neighbor user equipment, and sending an indicator in downlink control information to the user equipment to indicate to the user equipment the user equipment can perform self-calibration of full duplex communication using the signaled one or more flexible symbols.

### EXAMPLE 5

The method of example 4, further comprising the base station instructing the user equipment to transmit a reservation signal, the reservation signal indicating to the one or more neighbor user equipment they should mute their transmissions during the gap.

### EXAMPLE 6

The method of any of examples 1 to 5, further comprising:

sending second requests by the base station to one or more base stations that are neighbors to the base station, the second requests indicating that the one or more neighbor base stations are to mute their downlink communications at least for the gap.

### EXAMPLE 7

The method of any of examples 1 to 6, wherein sending indication of the gap toward the user equipment comprises sending an uplink grant in one of MSG2, MSGB or downlink control information, wherein the uplink grant indicates the gap.

### EXAMPLE 8

The method of example 7, wherein the uplink grant comprises one or more of the following:

a frequency domain resource allocation field indicating an invalid allocation;

an SLIV field indicates symbols of the gap; or

a K2 field indicates a slot where the gap is scheduled.

### EXAMPLE 9

The method of any of examples 1 to 6, wherein sending indication of the gap toward the user equipment comprises the base station scheduling the user equipment for one or more specific sounding reference signals, which indicate to the user equipment to use the specific one or more sounding reference signals as the gap.

### EXAMPLE 10

The method of any of examples 1 to 9, wherein indication of the gap comprises a configuration of the gap with one or more of the following: periodicity; offset; bitmap indicating one or more symbols of the gap within a slot; or offset of reservation signal with respect to the gap and wherein sending indication of the gap further comprises sending by the base station indication of the configuration to the user equipment.

### EXAMPLE 11

The method of any of examples 1 to 10, wherein the base station determines a symbol of the gap as an earliest gap in a set of gaps, the earliest gap occurring after at least one of the received messages indicating the user equipment requests the gap or sending the indication of the gap, such that processing timelines are met.

### EXAMPLE 12

A method, comprising:

sending, by a user equipment in a wireless network and toward a base station in the wireless network, a message indicating the user equipment requests a gap in order for the user equipment to perform self-calibration of full duplex calibration;

receiving, at the user equipment and from the base station, indication of the gap; and

performing by the user equipment the self-calibration of full duplex calibration using the gap.

### EXAMPLE 13

The method of example 12, wherein performing by the user equipment full duplex calibration using the gap comprises transmitting one or more reference signals in resources corresponding to the gap and performing the full duplex calibration based on the transmitted one or more reference signals.

### EXAMPLE 14

The method of example 13, wherein the one or more reference signals comprise sounding reference signals.

### EXAMPLE 15

The method of any of examples 12 to 14, wherein the sending the message indicating the user equipment requests the gap comprises one of the following:

sending by the user equipment a MSG 1, where a specific subset of random access channel occasions are configured to the user equipment in a dedicated manner for indication of the request for the gap;

sending by the user equipment a MSG A, where a configured PUSCH associated with the preamble/RO contains a one bit flag for indication of the request for the gap;

sending by the user equipment a scheduling request, wherein one or more out scheduling configurations are linked to the indication of the request for the gap instead of indicating a logical channel; or

sending by the user equipment one more bit in a hybrid automatic repeat request-acknowledgement codebook to indicate the request for the gap.

### EXAMPLE 16

The method of any of examples 12 to 15, wherein at least the sending of the message indicating the user equipment requests the gap is triggered periodically based on one or more environmental parameters comprising one or more values of the following: temperature; battery voltage; transmission power; or inertial measurement unit sensor data.

### EXAMPLE 17

The method of any of examples 12 to 16, wherein at least the sending of the message indicating the user equipment requests the gap is triggered based on a detected mismatch in a power amplifier or low noise amplifier or both on the user equipment, and the mismatch is caused at least in part by human interaction with the user equipment.

### EXAMPLE 18

The method of any of examples 12 to 17, further comprising:

switching, by the user equipment and in response to the sending the message indicating the user equipment requests the gap, to a half-duplex mode; and

switching, by the user equipment and in response to the full duplex calibration being performed, to a full duplex mode.

### EXAMPLE 19

The method of any of examples 12 to 18, wherein receiving indication of the gap comprises receiving an uplink grant in one of MSG2, MSGB or downlink control information, wherein the uplink grant indicates the gap.

### EXAMPLE 20

An apparatus, comprising:

one or more processors; and

one or more memories including computer program code,

wherein the one or more memories and the computer program code are configured, with the one or more processors, to cause the apparatus to perform operations comprising:

receiving, at a base station in a wireless network and from a user equipment in the wireless network, a message indicating the user equipment requests a gap for the user equipment to perform self-calibration of full-duplex communication;

determining by the base station the gap for the user equipment to use to perform the self-calibration of full duplex communication; and

sending by the base station indication of the gap toward the user equipment.

### EXAMPLE 21

The apparatus of example 20, wherein the one or more memories and the computer program code are further configured, with the one or more processors, to cause the apparatus to perform operations comprising:

sending requests to one or more user equipment that are neighbors to the user equipment and are in at least one cell formed by the base station, the requests indicating that the neighbor user equipment are to mute their uplink communications at least for the gap.

### EXAMPLE 22

The apparatus of example 21, wherein sending the requests uses group common physical downlink control channel signaling of one or more flexible symbols to be used for the gap.

### EXAMPLE 23

The apparatus of example 22, wherein sending the requests sends the requests to both the user equipment and the one or more neighbor user equipment, and sending an indicator in downlink control information to the user equipment to indicate to the user equipment the user equipment can perform self-calibration of full duplex communication using the signaled one or more flexible symbols.

### EXAMPLE 24

The apparatus of example 23, wherein the one or more memories and the computer program code are further configured, with the one or more processors, to cause the apparatus to perform operations comprising: the base station instructing the user equipment to transmit a reservation signal, the reservation signal indicating to the one or more neighbor user equipment they should mute their transmissions during the gap.

### EXAMPLE 25

The apparatus of any of examples 20 to 24, wherein the one or more memories and the computer program code are further configured, with the one or more processors, to cause the apparatus to perform operations comprising:

sending second requests by the base station to one or more base stations that are neighbors to the base station, the second requests indicating that the one or more neighbor base stations are to mute their downlink communications at least for the gap.

### EXAMPLE 26

The apparatus of any of examples 20 to 25, wherein sending indication of the gap toward the user equipment comprises sending an uplink grant in one of MSG2, MSGB or downlink control information, wherein the uplink grant indicates the gap.

### EXAMPLE 27

The apparatus of example 26, wherein the uplink grant comprises one or more of the following:

a frequency domain resource allocation field indicating an invalid allocation;

an SLIV field indicates symbols of the gap; or

a K2 field indicates a slot where the gap is scheduled.

### EXAMPLE 28

The apparatus of any of examples 20 to 25, wherein sending indication of the gap toward the user equipment comprises the base station scheduling the user equipment for one or more specific sounding reference signals, which indicate to the user equipment to use the specific one or more sounding reference signals as the gap.

### EXAMPLE 29

The apparatus of any of examples 20 to 28, wherein indication of the gap comprises a configuration of the gap with one or more of the following: periodicity; offset; bitmap indicating one or more symbols of the gap within a slot; or offset of reservation signal with respect to the gap and wherein sending indication of the gap further comprises sending by the base station indication of the configuration to the user equipment.

### EXAMPLE 30

The apparatus of any of examples 20 to 29, wherein the base station determines a symbol of the gap as an earliest gap in a set of gaps, the earliest gap occurring after at least one of the received messages indicating the user equipment requests the gap or sending the indication of the gap, such that processing timelines are met.

### EXAMPLE 31

An apparatus, comprising:

one or more processors; and

one or more memories including computer program code,

wherein the one or more memories and the computer program code are configured, with the one or more processors, to cause the apparatus to perform operations comprising:

sending, by a user equipment in a wireless network and toward a base station in the wireless network, a message indicating the user equipment requests a gap in order for the user equipment to perform self-calibration of full duplex calibration;

receiving, at the user equipment and from the base station, indication of the gap; and

performing by the user equipment the self-calibration of full duplex calibration using the gap.

### EXAMPLE 32

The apparatus of example 31, wherein performing by the user equipment full duplex calibration using the gap comprises transmitting one or more reference signals in resources corresponding to the gap and performing the full duplex calibration based on the transmitted one or more reference signals.

### EXAMPLE 33

The apparatus of example 32, wherein the one or more reference signals comprise sounding reference signals.

### EXAMPLE 34

The apparatus of any of examples 31 to 33, wherein the sending the message indicating the user equipment requests the gap comprises one of the following:

sending by the user equipment a MSG 1, where a specific subset of random access channel occasions are configured to the user equipment in a dedicated manner for indication of the request for the gap;

sending by the user equipment a MSG A, where a configured PUSCH associated with the preamble/RO contains a one bit flag for indication of the request for the gap;

sending by the user equipment a scheduling request, wherein one or more out scheduling configurations are linked to the indication of the request for the gap instead of indicating a logical channel; or

sending by the user equipment one more bit in a hybrid automatic repeat request-acknowledgement codebook to indicate the request for the gap.

### EXAMPLE 35

The apparatus of any of examples 31 to 34, wherein at least the sending of the message indicating the user equipment requests the gap is triggered periodically based on one or more environmental parameters comprising one or more values of the following: temperature; battery voltage; transmission power; or inertial measurement unit sensor data.

### EXAMPLE 36

The apparatus of any of examples 31 to 35, wherein at least the sending of the message indicating the user equipment requests the gap is triggered based on a detected mismatch in a power amplifier or low noise amplifier or both on the user equipment, and the mismatch is caused at least in part by human interaction with the user equipment.

### EXAMPLE 37

The apparatus of any of examples 31 to 36, wherein the one or more memories and the computer program code are further configured, with the one or more processors, to cause the apparatus to perform operations comprising:

switching, by the user equipment and in response to the sending the message indicating the user equipment requests the gap, to a half-duplex mode; and

switching, by the user equipment and in response to the full duplex calibration being performed, to a full duplex mode.

### EXAMPLE 38

The apparatus of any of examples 31 to 37, wherein receiving indication of the gap comprises receiving an uplink grant in one of MSG2, MSGB or downlink control information, wherein the uplink grant indicates the gap.

### EXAMPLE 39

An apparatus, comprising:

means for receiving, at a base station in a wireless network and from a user equipment in the wireless network, a message indicating the user equipment requests a gap for the user equipment to perform self-calibration of full-duplex communication;

means for determining by the base station the gap for the user equipment to use to perform the self-calibration of full duplex communication; and

means for sending by the base station indication of the gap toward the user equipment.

### EXAMPLE 40

The apparatus of example 39, further comprising means for performing the method of any of examples 2 to 11.

### EXAMPLE 41

An apparatus, comprising:

means for sending, by a user equipment in a wireless network and toward a base station in the wireless network, a message indicating the user equipment requests a gap in order for the user equipment to perform self-calibration of full duplex calibration;

means for receiving, at the user equipment and from the base station, indication of the gap; and

means for performing by the user equipment the self-calibration of full duplex calibration using the gap.

### EXAMPLE 42

The apparatus of example 41, further comprising means for performing the method of any of examples 13 to 19.

### EXAMPLE 43

A wireless communication system comprising any of the apparatus of examples 39 or 40 and any of the apparatus of examples 41 or 42.

As used in this application, the term “circuitry” may refer to one or more or all of the following:

(a) hardware-only circuit implementations (such as implementations in only analog and/or digital circuitry) and

(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and

(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1.-11. (canceled)

12. A method, comprising:
sending, by a user equipment in a wireless network and toward a base station in the wireless network, a message indicating the user equipment requests a gap in order for the user equipment to perform self-calibration of full duplex calibration;
receiving, at the user equipment and from the base station, indication of the gap; and
performing by the user equipment the self-calibration of full duplex calibration using the gap.

13. The method of claim 12, wherein performing by the user equipment full duplex calibration using the gap comprises transmitting one or more reference signals in resources corresponding to the gap and performing the full duplex calibration based on the transmitted one or more reference signals.

14.-19. (canceled)

20. An apparatus, comprising:
one or more processors; and
one or more memories including computer program code,
wherein the one or more memories and the computer program code are configured, with the one or more processors, to cause the apparatus to perform operations comprising:
receiving, at a base station in a wireless network and from a user equipment in the wireless network, a message indicating the user equipment requests a gap for the user equipment to perform self-calibration of full-duplex communication;
determining by the base station the gap for the user equipment to use to perform the self-calibration of full duplex communication; and
sending by the base station indication of the gap toward the user equipment.

21. The apparatus of claim 20, wherein the one or more memories and the computer program code are further configured, with the one or more processors, to cause the apparatus to perform operations comprising:
sending requests to one or more user equipment that are neighbors to the user equipment and are in at least one cell formed by the base station, the requests indicating that the neighbor user equipment are to mute their uplink communications at least for the gap.

22. The apparatus of claim 21, wherein sending the requests uses group common physical downlink control channel signaling of one or more flexible symbols to be used for the gap.

23. The apparatus of claim 22, wherein sending the requests sends the requests to both the user equipment and the one or more neighbor user equipment, and sending an indicator in downlink control information to the user equipment to indicate to the user equipment the user equipment can perform self-calibration of full duplex communication using the signaled one or more flexible symbols.

24. The apparatus of claim 23, wherein the one or more memories and the computer program code are further configured, with the one or more processors, to cause the apparatus to perform operations comprising: the base station instructing the user equipment to transmit a reservation signal, the reservation signal indicating to the one or more neighbor user equipment they should mute their transmissions during the gap.

25. The apparatus of claim 20, wherein the one or more memories and the computer program code are further configured, with the one or more processors, to cause the apparatus to perform operations comprising:
sending second requests by the base station to one or more base stations that are neighbors to the base station, the second requests indicating that the one or more neighbor base stations are to mute their downlink communications at least for the gap.

26. The apparatus of claim 20, wherein sending indication of the gap toward the user equipment comprises sending an uplink grant in one of MSG2, MSGB or downlink control information, wherein the uplink grant indicates the gap.

27. The apparatus of claim 26, wherein the uplink grant comprises one or more of the following:
a frequency domain resource allocation field indicating an invalid allocation;
an SLIV field indicates symbols of the gap; or
a K2 field indicates a slot where the gap is scheduled.

28. The apparatus of c1aim 20, wherein sending indication of the gap toward the user equipment comprises the base station scheduling the user equipment for one or more specific sounding reference signals, which indicate to the user equipment to use the specific one or more sounding reference signals as the gap.

29. The apparatus of claim 20, wherein indication of the gap comprises a configuration of the gap with one or more of the following: periodicity; offset; bitmap indicating one or more symbols of the gap within a slot; or offset of reservation signal with respect to the gap and wherein sending indication of the gap further comprises sending by the base station indication of the configuration to the user equipment.

30. The apparatus of claim 20, wherein the base station determines a symbol of the gap as an earliest gap in a set of gaps, the earliest gap occurring after at least one of the received messages indicating the user equipment requests the gap or sending the indication of the gap, such that processing timelines are met.

31. An apparatus, comprising:
one or more processors; and
one or more memories including computer program code,
wherein the one or more memories and the computer program code are configured, with the one or more processors, to cause the apparatus to perform operations comprising:
sending, by a user equipment in a wireless network and toward a base station in the wireless network, a message indicating the user equipment requests a gap in order for the user equipment to perform self-calibration of full duplex calibration;
receiving, at the user equipment and from the base station, indication of the gap; and
performing by the user equipment the self-calibration of full duplex calibration using the gap.

32. The apparatus of claim 31, wherein performing by the user equipment full duplex calibration using the gap comprises transmitting one or more reference signals in resources corresponding to the gap and performing the full duplex calibration based on the transmitted one or more reference signals.

33. The apparatus of claim 32, wherein the one or more reference signals comprise sounding reference signals.

34. The apparatus of claim 31, wherein the sending the message indicating the user equipment requests the gap comprises one of the following:
sending by the user equipment a MSG 1, where a specific subset of random access channel occasions are configured to the user equipment in a dedicated manner for indication of the request for the gap;
sending by the user equipment a MSG A, where a configured PUSCH associated with the preamble/RO contains a one bit flag for indication of the request for the gap;
sending by the user equipment a scheduling request, wherein one or more out scheduling configurations are linked to the indication of the request for the gap instead of indicating a logical channel; or
sending by the user equipment one more bit in a hybrid automatic repeat request-acknowledgement codebook to indicate the request for the gap.

35. The apparatus of claim 31, wherein at least the sending of the message indicating the user equipment requests the gap is triggered periodically based on one or more environmental parameters comprising one or more values of the following: temperature; battery voltage; transmission power; or inertial measurement unit sensor data.

36. The apparatus of claim 31, wherein at least the sending of the message indicating the user equipment requests the gap is triggered based on a detected mismatch in a power amplifier or low noise amplifier or both on the user equipment, and the mismatch is caused at least in part by human interaction with the user equipment.

37. The apparatus of claim 31, wherein the one or more memories and the computer program code are further configured, with the one or more processors, to cause the apparatus to perform operations comprising:
switching, by the user equipment and in response to the sending the message indicating the user equipment requests the gap, to a half-duplex mode; and
switching, by the user equipment and in response to the full duplex calibration being performed, to a full duplex mode.

38. The apparatus of claim 31, wherein receiving indication of the gap comprises receiving an uplink grant in one of MSG2, MSGB or downlink control information, wherein the uplink grant indicates the gap.

39.-43. (canceled)
